(19) United States
(12) Patent Application Publication
(10) Pub. No.: US 2025/0205662 A1
(43) Pub. Date: Jun. 26, 2025

(54) CONTAINER DRIVE FOR A TRAJECTORY

(71) Applicant: hs-tumbler GmbH, Quakenbrück (DE)

(72) Inventor: Bernhard Hukelmann, Quakenbrück (DE)

(21) Appl. No.: 18/849,264

(22) PCT Filed: Mar. 24, 2023
(86) PCT No.: PCT/EP2023/057720

§ 371 Date: Sep. 20, 2024

(30) Foreign Application Priority Data
Mar. 24, 2022 (DE) 102022202904.6

(51) Int. Cl. B01F 31/00; B01F 31/22; B01F 35/32

(52) U.S. Cl. CPC B01F 31/70; B01F 31/22; B01F 35/3204; B01F 35/325

(57) ABSTRACT

A drive with which a container can be driven and positively guided in a plane along a trajectory curve, and a method for treating ingredients, in particular mixtures, in a container which is driven and positively guided along a trajectory curve by means of the drive. The drive has the advantage of using only rotary drives to move a container in a positively guided reciprocating movement along a trajectory curve.

The present invention relates to a drive by which a container can be driven and positively guided in a plane along a trajectory curve, and to a method for treating ingredients, in particular mixtures, in a container which is driven and positively guided along a trajectory curve by means of the drive.

The drive has the advantage of moving a container in a positively driven reciprocating movement along a trajectory curve, in particular without a linear drive, preferably exclusively with rotary drives and rotary bearings. In an optional embodiment, the drive does not have a linear guide or link guide.

The object of the invention is to provide an alternative drive that enables a reciprocating movement along a trajectory curve, preferably only has rotary motors and optionally should not have a linear drive.

The invention achieves the object by the features of the claims and in particular by means of a drive which has a first lever articulated on a first stationary pivot bearing, opposite to the first pivot bearing and articulated on the first lever in a first connecting bearing a second lever, on which a retainer for a container is mounted opposite to the first lever, a third lever articulated to a second stationary pivot bearing, opposite to the second stationary pivot bearing and articulated to the third lever in a second connecting bearing a fourth lever, to which lever the retainer for a container is attached opposite to the third lever, wherein the first stationary pivot bearing and the second stationary pivot bearing are fixed relative to each other, pivotable at a distance from each other or about the same pivot axis, and wherein at least one, preferably each, of the second lever and the fourth lever is pivotably hinged to the retainer for a container. In that one or each of the second and fourth levers is pivotably, also referred to as rotatably, articulated to the retainer for a container, the retainer of the container is attached to the second and fourth levers in such a way that the second and fourth levers are pivotable relative to one another on the retainer for a container.

Since the first stationary pivot bearing and the second stationary pivot bearing are fixed relative to each other, they form spaced stationary bearings, or stationary bearings with spaced pivot axes, or stationary bearings with a common pivot axis for the first lever and the second lever articulated to it as well as for the third lever and the fourth lever articulated to it. Opposite the stationary bearing, the second and fourth levers form a floating bearing on the retainer for a container.

One of each of the first and second levers and one of each of the third and fourth levers is driven by an eccentric drive, e.g. each with a separate rotary motor or a common rotary motor with an intermediate transmission. An eccentric drive can be articulated to one of the first and second levers and to one of the third and fourth levers, which eccentric drive preferably is arranged in a stationary position, alternatively slidably, relative to the first and second pivot bearing. Therein, a first eccentric drive is articulated on the first lever or on the second lever, and a second eccentric drive is articulated on the third lever or on the fourth lever. Preferably, a first eccentric drive is articulated on the first lever and a second eccentric drive is articulated on the third lever. Therein, each eccentric drive can be articulated to a lever in that a link guide, which extends at least in sections along the lever, is attached to the lever, and a drive pin driven by a rotary motor for movement along a circular path or for circular movement is guided in the link guide.

The drive for the reciprocating movement of the retainer of a container along a trajectory curve preferably has a first lever articulated on a first stationary pivot bearing, opposite to the first pivot bearing a second lever articulated on the first lever in a first connecting bearing, on which second lever retainer for a container is mounted opposite the first lever, a third lever articulated on a second stationary pivot bearing, opposite to the second stationary pivot bearing a fourth lever articulated on the third lever in a second connecting bearing, on which fourth lever, opposite to the third lever, the retainer for the container is attached, wherein the first stationary pivot bearing and the second stationary pivot bearing are fixed relative to one another with a spacing from one another or pivotable about the same pivot axis, and wherein at least one of the second lever and the fourth lever is articulated on to the retainer of the container, with a first eccentric drive which is connected to one of the first lever and the second lever, e.g. articulated, and with a second eccentric drive which is connected to one of the third lever and the fourth lever, e.g. articulated.

The first connecting bearing, which pivotably articulates the first lever on the second lever, is a floating bearing, and the second connecting bearing, which pivotably articulates the third lever on the fourth lever, is a floating bearing.

Opposite the first lever, the retainer of a container is attached to the second lever, preferably on a third pivot bearing. Opposite the third lever, the retainer of a container is attached to the fourth lever, preferably on a fourth pivot bearing, wherein the third pivot bearing and the fourth pivot bearing can be attached to the retainer of the container at a distance from each other, or with a common pivot axis. Optionally, opposite to the first lever the retainer of a container is fixedly connected to the second lever and the fourth lever is pivotably articulated to the retainer of a container in a pivot bearing.

Preferably, the pivot axes of the first pivot bearing and of the second pivot bearing as well as the pivot axes of the first and second connecting bearings and the pivot axes of the third and fourth pivot bearings are arranged parallel to each other.

The first pivot bearing and the second pivot bearing, as well as the first and second eccentric drives, can be mounted in a stationary position on a common frame, the first and second connecting bearings and the retainer of a container being movable relative to the frame, wherein the retainer of the container is preferably guided only by the second lever, which is articulated on the first lever, and by the fourth lever, which is articulated on the third lever.

The first and/or the second eccentric drives can each be formed by a rotary drive with an eccentric drive arm on it. For example, a drive arm of the first eccentric drive is pivotably connected to one of the first and second levers, while a drive arm of the second eccentric drive is pivotably connected to one of the third and fourth levers.

Alternatively, the first and/or the second eccentric drive can each be formed by a rotary drive which is formed by a drive pin which is slidable in a guide and which is driven by a rotary drive, in particular along a circular path, resp. for circular movement. At least one or both of the eccentric drives can have a link guide, which extends along the lever driven by the eccentric drive, and a drive pin guided in the link guide and driven by a rotary motor.

Optionally, the first and second eccentric drives are driven by a common motor, preferably with a transmission, which is further preferably shiftable in order to drive the eccentric drives with a constant or variable speed ratio to each other. The transmission is preferably a belt gearbox or a friction gearbox.

The first and second eccentric drives can each be driven by a motor, one or both of which are controlled in order to drive the eccentric drives with a constant or variable speed ratio relative to one another. Alternatively, the first eccentric drive and the second eccentric drive can be driven by a common controlled and stationarily mounted rotary motor with a transmission, wherein the transmission is preferably set up to change the transmission ratio and/or the phase offset for the two eccentric drives relative to each other.

The drive according to the invention has the advantage that it is driven by two rotary motors with eccentric drive or one rotary motor with a transmission and eccentric and, for example, in an embodiment has no linear drive and no linear guides or sliding block guides.

The drive is set up for the reciprocating movement of the container along a trajectory curve, e.g. with a rotational frequency of one or both eccentric drives, equal or different, of at least 1 Hz, in order to drive the reciprocating movement of the retainer of a container. The trajectory curve of the reciprocating movement is generated by superimposing the movement along two axes, each with a different frequency and/or with a phase offset of the rotational frequency of the eccentric drives, e.g. over a path along each axis of preferably at least 2.5 mm, at least 1 cm, at least 2 cm or at least 3 cm or at least 10 cm, e.g. up to 50 cm, up to 30 cm, up to 20 cm or, in the case of shorter paths, up to 10 cm.

The reciprocating movement of the retainer of a container can, for example, extend over a distance of at least 1.5 mm, preferably at least 3 mm, preferably at least 1 cm, preferably at least 2 cm or at least 5 cm, at least 10 cm or at least 15 cm, e.g. up to 50 cm, up to 30 cm or up to 20 cm. Further preferably, the eccentric drives for moving the container reciprocating are controlled harmoniously along a trajectory curve. The reciprocating movement is non-linear and can be sinusoidal, loop-shaped or arc-shaped, preferably running along a trajectory curve that is preferably in the plane or two-dimensional. This is because, in general, a non-linear axis of movement, preferably resp. reciprocating movement along a trajectory curve, which may be a Lissajous figure or hypocycloid, promotes uniform and intensive mixing of components of a composition contained in a container attached to the retainer of a container, even for components of the composition having a similar or equal specific gravity. Each axis of movement can be linear or arcuate, so that the non-linear movement of the container is generated from the superposition of movements along two axes of movement.

The retainer of a container is driven for reciprocating movement along at least one trajectory curve which can be generated by superimposing the reciprocating movement along at least two axes which lie at an angle to one another, preferably two of the axes lying in the plane of the cross-section of the container to be attached to the retainer of a container, the reciprocating movement along each axis taking place at different frequencies and/or with a phase offset. The trajectory curve can be generated by superimposing the reciprocating movement along two or three axes at different frequencies and/or with phase offset and has a sequence of path segments, at least one of which, preferably each, comprises or consists of exactly one complete reciprocating movement along the axis along which the reciprocating movement takes place at the lower frequency, wherein the superimposed reciprocating movements at the higher frequency or the same frequency, in each case optionally with phase offset, along the other axis or axes are comprised. The lower frequency of the complete reciprocating movement forms the frequency of the sequence of path segments. At least one of the eccentric drives, preferably both, is controlled to rotate at the frequency. For each path segment, a frequency ratio of the reciprocating movement along two axes of at maximum 1:20 or at maximum 1:15 or at maximum 1:10, at maximum 1:4 or at maximum 1:3 is preferred, more preferably between 1:1 and 1:2, even more preferably greater than 1:1 to 1:2 or up to 1:1.5, e.g. with a frequency ratio of 1:1.001 to 1:2 or up to 1:1.5.

In the case of a trajectory curve that can be generated by superimposing the reciprocating movement along two axes at different frequencies and/or with phase offset of the rotation of the eccentric drives, the axes preferably lie in the plane of the cross-section of the container that is to be attached to the retainer of a container. In general, the linear or arcuate axes of movement are preferably at right angles to each other. In general, the trajectory curve does not include any rotation of the retainer of a container or of the container about its own axis.

In general, the device is set up to drive the retainer of a container for the container along a trajectory curve which is formed by superimposing the reciprocating movement of at least two superimposed linear or arcuate axes which are at an angle to one another, the reciprocating movement along the axes taking place at different frequencies and/or with a phase offset. The axes along which the superimposed reciprocating movements take place at different frequencies and/or with a phase offset form the trajectory curve along which the reciprocating movement of the retainer of the container and the container attached to it takes place.

By moving the retainer of the container along the trajectory curve, the device is set up to accelerate components in the container relative to the container, so that solids and/or liquids as components contained in the container are sheared by the acceleration against the container wall and by the movement along or against the container wall and are thereby intensively mixed.

Since the trajectory curve can be adjusted or predetermined by the different frequencies and/or the phase offset of the superimposed movements along the axes, the device is set up for the reciprocating movement of the retainer of the container and the container attached to it along the trajectory curve and for the relative movement of components, resp. their mixture, with respect to the container.

Generally preferably, the retainer of the container and the container therein are not rotationally driven and further preferably not or not fully rotatable, e.g. articulated so as to be rotatable by a maximum of 30° or by a maximum of 20° or 10° about its centre axis. Generally preferred, the container is driven exclusively for a reciprocating movement along a trajectory curve.

The trajectory curve, which can be adjusted or predetermined by the different frequencies and/or the phase offset of the superimposed movements along at least two axes, accelerates solids and/or liquids as components and a mixture of these relative to the container, which is attached to the retainer of a container. The reciprocating movement of the container drives the components in the container and the mixture thereof to move against the inner wall of the container.

The trajectory curve can be used to determine the angle of incidence and the angle of projection of the solids and/or liquids and the mixture of these against the container wall. In addition, the device is optionally set up to move the retainer of the container and the container on it along the trajectory curve with adjustable or predetermined acceleration and speed. In that the device is arranged for an adjustable or predetermined trajectory and/or an adjustable or predetermined acceleration and/or an adjustable or predetermined speed along the trajectory curve of the reciprocating movement, solids and/or liquids and the mixture thereof are driven with adjustable or predetermined acceleration and/or speed relative to the container and allows a predetermined or continuous adaptation of the process to the solids and/or liquids and to the mixture thereof.

In general, a trajectory curve can be formed by at least two superimposed individual oscillations; preferably, a trajectory curve resembles the trajectory curve that can be generated by superimposing reciprocating movements along at least two linear or arcuate axes of movement at different frequencies and/or by phase offset. A reciprocating movement along a trajectory curve that is similar to the reciprocating movement along linear or arcuate axes of movement that are superimposed on each other have different frequencies and/or a phase offset to each other. In general, a trajectory curve is therefore not a circular path.

The difference in frequencies can, for example, be at least 0.01 Hz and/or 0.01% to 900%. The phase offset of the reciprocating movements along the linear axes can be, for example, from 0.01° to 180°, preferably 1 to 179° of 360°, which corresponds to a complete reciprocating movement. In this case, 0.01 to 180° of a complete reciprocating movement of 360° is equal to 0.0028% to 50% of a complete reciprocating movement, 1 to 179° of 360° is equal to 0.28% to 49.7% of a complete reciprocating movement.

Therein, the linear or arcuate axes of movement are, for example, perpendicular or at a different angle, e.g. 5° to 85° to each other, in particular in the plane of the cross-section of the container and/or perpendicular to a centre axis of a container attached to the retainer for a container. Optionally, the trajectory curve contains at least one straight-line section, the end of which is, for example, an apex of the trajectory curve, at which the solids and/or liquids and the mixture thereof are accelerated away from the container wall or against the container wall.

To set different frequencies and/or a phase offset of the superimposed reciprocating movements along at least two movement axes, these reciprocating movements can be coupled together by a transmission or a link guide and driven by a motor. A transmission driven by a motor, which adjusts the reciprocating movement along the trajectory curve, can have a fixed transmission ratio between the superimposed movements along each axis, or an adjustable transmission ratio, e.g. a continuously or incrementally shiftable gearbox. Optionally, the gearbox can be slip-controlled, e.g. have a belt drive or be a friction gearbox.

The output rotational speed of the transmission, which drives one or both of the eccentric drives, is preferably at least 1 Hz, more preferably at least 2.5 Hz, more preferably at least 5 Hz, more preferably at least 7 Hz, e.g. up to 50 Hz, up to 40 Hz, up to 30 Hz, up to 20 Hz or up to 10 Hz. The output rotational speed of the gearbox is equal to the frequency of the reciprocating movement.

Alternatively, the reciprocating movement along each of the axes of motion may be driven by a separate motor, wherein for the purposes of the invention the lower output rotational speed is the frequency of the reciprocating motion and forms the frequency of the sequence of path segments. In any embodiment, the rotational speed of each drive motor may be controlled, fixed or variable over the duration of the process.

Therein, the device allows the trajectory curve to accelerate the solids and/or liquids as components and the mixture of these in a defined direction to a specific location on the inner wall of the container. The geometry of the container and its inner wall can support the mixing process in conjunction with the trajectory curve, so that the trajectory curve can be adjusted depending on the shape and size of the container cross-section.

Optionally, the device is set up to change the trajectory curve of the reciprocating movement and/or the acceleration and/or speed of the reciprocating movement during the process, e.g. in a first phase to set the reciprocating movement along a first trajectory curve and with a first acceleration and speed and to set the reciprocating movement in a subsequent second phase along a changed trajectory curve and/or changed acceleration and/or speed.

Further optionally, the reciprocating movement is a linear reciprocating movement in a first phase and a reciprocating movement along merging trajectory curves in a second phase. Therein, the trajectory curve can, for example, be determined by a transmission that drives the movement of the container.

By adjusting the trajectory curve and acceleration of the reciprocating movement of the container, the device allows a predetermined or dynamically variable and directed acceleration of the contents as process material relative to the container.

In an embodiment, in which the container can be controlled to be driven to a linear reciprocating movement in a first phase, the device is set up to move solids and/or liquids and the mixture of these in perpendicular against the container wall in a controllable acceleration which is significantly larger than gravity and therefore is essentially independent from gravity, e.g. with a maximum of the acceleration of at least 15 m/s², preferably 25 m/s², preferably at least 50 m/s² or at least 100 m/s² or at least 200 m/s² or at least 350 m/s², e.g. up to 500 m/s² in each case.

In general, the device can be set up to accelerate the retainer of the container and a container attached to it with an maximum of the acceleration of at least 20 m/s² or at least 100 m/s², e.g. at least 200 m/s², preferably up to 1000 m/s² or up to 300 m/s² along the trajectory segments, e.g. at an apex of the trajectory segments.

The retainer of a container and the container attached to it are preferably driven to a reciprocating movement with a maximum acceleration of at least 0.5 m/s² or at least 1 m/s² or at least 2 m/s², at least 3.5 m/s², preferably at least 60 m/s², more preferably at least 100 m/s², at least 150 m/s², at least 160 m/s², at least 200 m/s², e.g. in each case up to 300 m/s² or 450 m/s², up to 260 m/s² or up to 250 m/s² along each of two axes. Generally preferably, the container is driven in combination with the acceleration to an average speed of at least 0.5 m/s, preferably at least 2 m/s, more preferably at least 3.5 m/s, e.g. up to 10 m/s or up to 20 m/s or up to 6 m/s, e.g. 3 to 4 m/s, in each case along one of the axes, preferably along each axis. The path of the movement along at least one axis, preferably along each axis, is e.g. 0.1 cm to 24 cm.

The retainer of a container and the container attached to it can, for example, be driven to perform a reciprocating movement which extends along each axis over a path of at least 1 mm or at least 2.5 mm, at least 1 cm, more preferably at least 2 cm or at least 5 cm, at least 10 cm or at least 15 cm, e.g. up to 100 cm, up to 50 cm, up to 30 cm or up to 20 cm in each case. Further preferably, the reciprocating movement of the container is harmonious. The reciprocating movement of the retainer of a container can be linear in a first phase, generally the trajectory curve is non-linear and can be sinusoidal, loop-shaped or arcuate, for example, preferably running along a so-called Lissajous figure or hypocycloid, which preferably lies in the plane resp. or is two-dimensional. Preferably, the reciprocating movement is linear in a first phase and in a second phase along at least two merging, non-linear trajectory segments, each containing at least one vertex, to form a trajectory curve. This is because a non-linear trajectory curve, e.g. a movement along a trajectory curve whose trajectory segments each have at least one vertex, generally promotes an impact of solids and/or liquids and the mixture of these, e.g. perpendicular to the container wall, as well as a movement along the container wall.

Preferably, the reciprocating movement comprises the reciprocating movement along a trajectory curve which comprises at least two, preferably at least three, more preferably at least four different path segments, each of which has at least one apex and preferably merges into one another in a time sequence, preferably program-controlled. Each of the movement axes along which the movements are superimposed to form a trajectory curve can be linear or arcuate, so that the non-linear movement of the retainer of the container along a sequence of path segments is generated from the superimposition of the movements along two movement axes. The apices and intermediate sections of a path segment are determined by the frequency difference and/or the phase position of the superimposed reciprocating movements along at least two axes. In general, the device can be set up to change the frequency difference and/or the phase position during the reciprocating movement.

The invention will now be described in more detail with reference to the figures, which are schematically show in

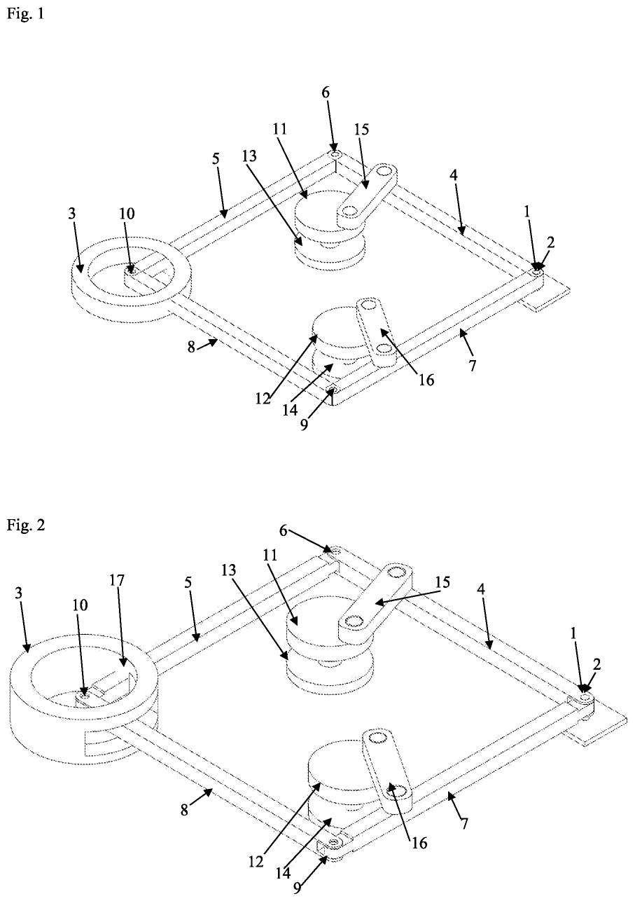

FIG. 1 an embodiment of the drive according to the invention,

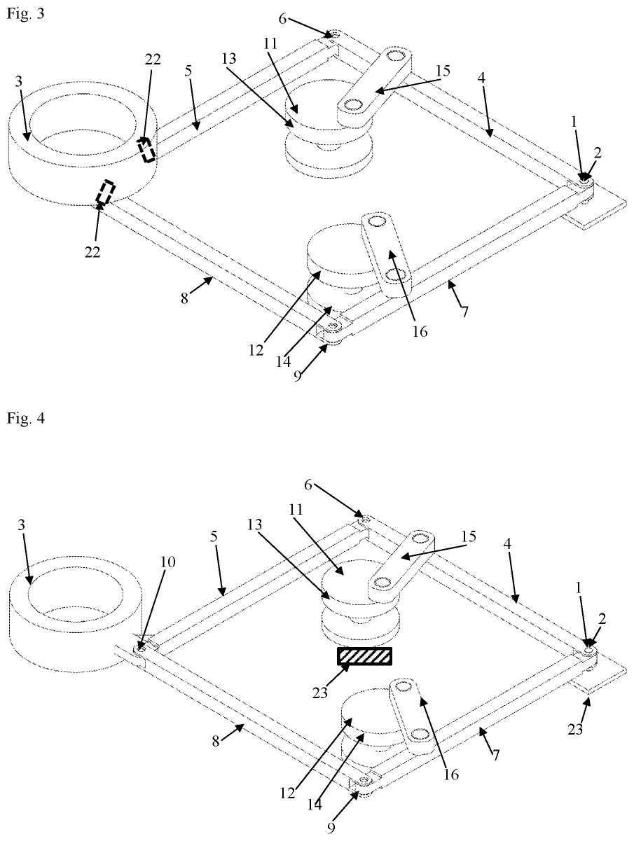

FIG. 2 an embodiment,

FIG. 3 an embodiment,

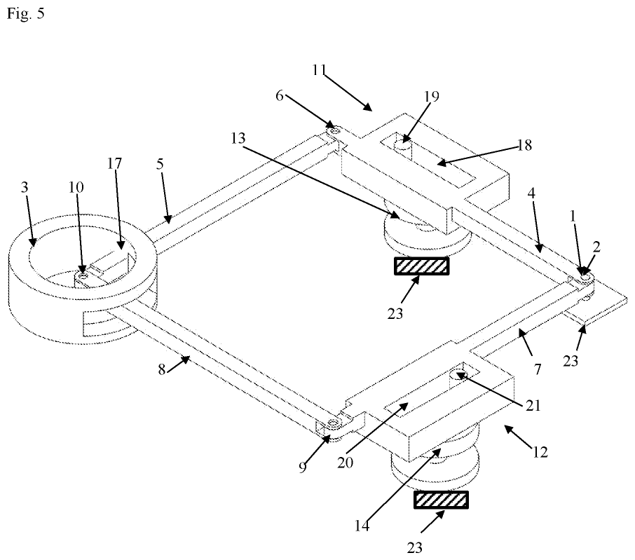

FIG. 4 an embodiment and in

FIG. 5 a still further embodiment.

In the figures, identical reference numbers denote elements with the same function.

FIG. 1 shows an embodiment of the drive according to the invention, which extends between a first stationary pivot bearing 1 and a second stationary pivot bearing 2 on the one hand and a floating bearing to which a retainer of the container 3 is attached on the other hand. A first lever 4 is pivotably articulated to the first pivot bearing 1, and a second lever 5 is pivotably articulated to its end opposite the first pivot bearing 1 by means of a first connecting bearing 6. The end of the second lever 5 opposite the first connecting bearing 6 is connected to the retainer of the container 3, preferably pivotably articulated to it. A third lever 7 is pivotably articulated to the second pivot bearing 2, and a fourth lever 8 is pivotably articulated to its end opposite the second pivot bearing 2 by means of a second connecting bearing 9. The end of the fourth lever 8 opposite the second connecting bearing 9 is connected to the retainer of the container 3, preferably pivotably articulated to it. In general, the second lever 5 and the fourth lever 8 can be attached to the retainer of the container 3 in that the second lever 5 and the fourth lever 8 are articulated to each other at a fourth pivot joint 10, and the retainer of the container 3 is attached to the axis of this fourth pivot joint 10 or to one of the second lever 5 and the fourth lever 8.

In the embodiment shown, the drive has two eccentric drives 11, 12, each with a controlled rotary motor 13, 14. A first eccentric drive 11 has a stationary first rotary motor 13, which is connected to the first lever 4 by means of an eccentric first drive arm 15, so that the first drive arm 15 drives the first lever 4 to pivot about the first pivot bearing 1. The second eccentric drive 12 has a stationarily mounted second rotary motor 14, which is connected to the third lever 7 by means of an eccentric second drive arm 16, so that the second drive arm 16 drives the third lever 7 for pivoting about the second pivot bearing 2. The first rotary motor 13 and the second rotary motor 14 are preferably arranged in a stationary position in that they are attached to a frame to which the first and second pivot bearings 1, 2 are also attached.

FIG. 2 shows in detail the fourth pivot joint 10, to which the second lever 5 and the fourth lever 8 are articulated to each other. The retainer of the container 3 can be firmly connected to the second lever 5 at a stationary point 17, while the fourth lever 8 is not directly connected to the retainer of a container 3, in particular it can be freely pivotable in relation to the retainer of a container 3.

FIG. 3 shows an embodiment in which the second lever 5 and the fourth lever 8 are not articulated directly to one another, but each is connected to the retainer of a container 3, wherein at least one of the second lever 5 and the fourth lever 8 is pivotably connected to the retainer of a container 3, or both the second lever 5 and the fourth lever 8 are pivotably connected to the retainer of a container 3. In FIG. 3, a pivot bearing 22 is shown between each of the second lever 5 and the fourth lever 8 and the retainer of a container 3.

FIG. 4 shows an embodiment in which both the second lever 5 and the fourth lever 8 are articulated directly to each other in a fourth pivot joint 10 and connected to the retainer of a container 3. The retainer of a container 3 can be connected to the second lever 5 in order to prevent uncontrolled movement of the retainer of a container 3 at the fourth pivot joint 10.

FIG. 5 shows an embodiment in which both the first eccentric drive 11 and the second eccentric drive 12 are each driven by a rotary motor 13, 14. The first rotary motor 13 drives a first drive bolt 19 along a circular path. The first drive bolt 19 is guided in a first guide 18, which extends along the first lever 4, so that the movement of the first drive bolt 19 leads to a pivoting of the first lever 4 about its first pivot bearing 1. The second eccentric drive is driven by a second rotary motor 14, which drives a second drive pin 21 along a circular path. The second drive pin is guided in the second guide 20, which extends along the third lever 7, so that the circular movement of the second drive pin 21 drives the third lever 7 to pivot about the second pivot bearing 2. A frame 23 is shown schematically, to which the first and second pivot bearings 1, 2 and the first and second eccentric drives 11, 12 are attached.

### REFERENCE SIGNS

1 first pivot bearing
2 second pivot bearing
3 retainer of the container
4 first lever
5 second lever
6 first connecting bearing
7 third lever
8 fourth lever
9 second connecting bearing
10 fourth pivot joint
11 first eccentric drive
12 second eccentric drive
13 first rotary motor
14 second rotary motor
15 first eccentric drive arm
16 second eccentric drive arm
17 stationary point
18 first guide
19 first drive pin
20 second guide
21 second drive pin
22 pivot bearing
23 frame

1. A drive for the reciprocating movement of a retainer of a container along a trajectory curve, the drive comprising:
a first lever articulated on a first stationary pivot bearing;
a second lever articulated on the first lever in a first connecting bearing opposite the first pivot bearing, wherein the retainer of the container is mounted on the second lever opposite the first lever;
a third lever articulated on a second stationary pivot bearing;
a fourth lever articulated on the third lever in a second connecting bearing opposite the second stationary pivot bearing, wherein the retainer of the container is mounted on the fourth lever opposite the third lever;
wherein the first stationary pivot bearing and the second stationary pivot bearing are fixed relative to one another, at a distance from one another or pivotable about the same pivot axis, and wherein at least one of the second lever and the fourth lever is pivotably articulated to the retainer of the container; the drive further comprising
a first eccentric drive connected to one of the first lever and the second lever, and a second eccentric drive connected to one of the third lever and the fourth lever.

2. The drive according to claim 1, wherein the first eccentric drive and the second eccentric drive each comprise a controlled rotary motor mounted in a stationary position.

3. The drive according to claim 2, wherein the controlled rotary motor of the first eccentric drive and the second eccentric drive are formed by a common rotary motor with a transmission.

4. The drive according to claim 1, wherein the first eccentric drive and the second eccentric drive are driven by a jointly controlled and stationarily mounted rotary motor with an intermediate transmission.

5. The drive according to claim 1, wherein at least one of the first eccentric drive and the second eccentric drive comprises an eccentric drive arm that pivotably connects a rotary motor to at least one of the first, second, third and fourth levers.

6. The drive according to claim 1, wherein in that at least one of the first eccentric drive and the second eccentric drive comprises a drive pin driven for circular movement guided in a guide.

7. The drive according to claim 1, wherein each of the second lever and fourth lever is pivotably articulated to the retainer of a container.

8. The drive according to claim 1, wherein the first and second eccentric drives and the first and second stationary pivot bearings are mounted on a common frame.

9. The drive according to claim 1, wherein at least one of the first and second eccentric drives is slidably mounted on a frame.

10. The drive according to claim 1, wherein the first and second stationary pivot bearings are arranged to be pivotable about a common pivot axis.

11. The drive according to claim 1, wherein the first eccentric drive and the second eccentric drive are controlled to be driven with different frequencies and/or with a phase offset.

12. A process for treating ingredients in a container mounted on the retainer of the drive of claim 1, comprising driving and positively guiding the container along the trajectory curve by controlling the first eccentric drive and the second eccentric drive to be driven with different frequencies and/or with a phase offset.
